(19) United States
(12) Patent Application Publication
(10) Pub. No.: US 2023/0291851 A1
(43) Pub. Date: Sep. 14, 2023

(54) DISPLAY PROCESSING APPARATUS, IMAGE PROCESSING APPARATUS, AND DISPLAY PROCESSING METHOD

(71) Applicant: SHARP KABUSHIKI KAISHA, Sakai City (JP)

(72) Inventor: NAOYA ARIFUKU, Sakai City (JP)

(21) Appl. No.: 18/099,830

(22) Filed: Jan. 20, 2023

(30) Foreign Application Priority Data
Feb. 3, 2022 (JP) 2022-015803

(51) Int. Cl. H04N 1/00; H04N 1/44

(52) U.S. Cl. CPC H04N 1/00517; H04N 1/4433; H04N 2201/0094

(57) ABSTRACT

According to an embodiment, a display processing apparatus includes: a display which can display setting history information related to execution of a job; and a controller which controls execution of the job by using the setting history information, and the controller determines necessity of the setting history information for the execution of the job, and also excludes, from pieces of setting history information each corresponding to the setting history information, a job being low in the necessity, and decides on order of display of the pieces of setting history information to be displayed on the display.

### BACKGROUND OF THE INVENTION

### Field of the Invention

The present disclosure relates to, for example, a display processing apparatus.

### Description of the Background Art

Some image processing apparatuses such as multifunction peripherals are related to execution of jobs such as printing, faxing, or e-mail transmission, and store, as setting history information, setting values related to execution of these jobs.

In recent years, as one technique to effectively use setting history information, there have been attempts to display stored setting history information on a display device, thereby enabling confirmation of a setting value related to execution of a job, or direct selection of the displayed setting history information on a screen, so that a job based on the selected setting history information can be executed.

As the user selects the desired setting history information from a plurality of pieces of setting history information displayed on a display device, he/she can easily execute a job based on the setting history information in question.

Incidentally, the number of pieces of setting history information that can be displayed on the display device is naturally limited by restrictions such as a display size of a screen, and specifications or the like of a screen configuration. Under such restrictions related to screen display, in order to perform effective display control for setting history information, restricting the display of old history setting history information when the number of displays on the display device reaches an upper limit is known, as indicated in a conventional technology, for example.

The conventional technology pertains to a technology of displaying pieces of setting history information in chronological order according to the order in which jobs are executed, and restricting the display of old history setting history information when the number of displays reaches the upper limit, whereby pieces of setting history information related to the latest jobs can be displayed.

However, displaying the pieces of setting history information in chronological order is not necessarily a mode to display setting history information as desired by the user. In a display mode in which pieces of setting history information are displayed in chronological order, display of setting history information related to a job of the oldest history, among the pieces of setting history information being displayed, is unconditionally restricted when a job is executed to exceed the upper limit of the number of displays. Consequently, if the setting history information related to the oldest job is setting history information that the user wishes to use, there has been a problem of being unable to refer to the setting history information that the user wishes to use, or execute a job based on the setting history information in question.

An object of the present disclosure is to provide a display processing apparatus, etc., capable of accurately displaying setting history information that the user wishes to use when executing a job.

### SUMMARY OF THE INVENTION

In order to solve the above problem, a display processing apparatus according to the present disclosure includes: a display which allows setting history information related to execution of a job to be displayed; and a controller which controls execution of the job by using the setting history information, in which the controller determines necessity of the setting history information for the execution of the job; and excludes, from pieces of setting history information each corresponding to the setting history information, the setting history information being low in the necessity, and decides on order of display of the pieces of setting history information to be displayed on the display.

Further, an image processing apparatus according to the present disclosure includes: the above-described display processing apparatus; and an image processor which executes image processing based on the job.

Furthermore, a display processing method according to the present disclosure includes: a display step of displaying setting history information related to execution of a job on a display device; and a control step of controlling execution of the job by using the setting history information, in which the control step includes: determining necessity of the setting history information for the execution of the job; and excluding, from pieces of setting history information each corresponding to the setting history information, the setting history information being low in the necessity, and deciding on order of display of the pieces of setting history information to be displayed on the display device.

According to the present disclosure, it is possible to provide a display processing apparatus, etc., capable of accurately displaying setting history information that the user wishes to use when executing a job.

### BRIEF DESCRIPTION OF THE DRAWINGS

FIG. 1 is a diagram illustrating an overall configuration of a multifunction peripheral according to a first embodiment.

FIG. 2 is a functional configuration diagram of the multifunction peripheral according to the first embodiment.

FIGS. 3A and 3B are diagrams illustrating a data structure of setting history information.

FIG. 4 is a table illustrating a data structure of job history information.

FIG. 5 is a flowchart illustrating a flow of processing of the first embodiment.

FIG. 6 is a flowchart illustrating a flow of processing of the first embodiment.

FIG. 7 is a flowchart illustrating a flow of processing of the first embodiment.

FIG. 8 is a flowchart illustrating a flow of processing of the first embodiment.

FIGS. 9A and 9B are diagrams illustrating an operation example of the first embodiment.

FIGS. 10A and 10B are diagrams illustrating an operation example of the first embodiment.

FIG. 11 is a table illustrating an operation example of the first embodiment.

FIG. 12 is a diagram illustrating an operation example of the first embodiment.

FIG. 13 is a table illustrating an operation example of the first embodiment.

FIG. 14 is a functional configuration diagram of a multifunction peripheral according to a second embodiment.

FIG. 15 is a flowchart illustrating a flow of processing of the second embodiment.

FIG. 16 is a flowchart illustrating a flow of processing of the second embodiment.

FIG. 17 is a diagram illustrating an operation example of the second embodiment.

FIG. 18 is a diagram illustrating an operation example of the second embodiment.

FIG. 19 is a flowchart illustrating a flow of processing of a third embodiment.

FIGS. 20A and 20B are diagrams illustrating an operation example of the third embodiment.

FIG. 21 is a flowchart illustrating a flow of processing of a fourth embodiment.

FIGS. 22A and 22B are diagrams illustrating an operation example of the fourth embodiment.

### DESCRIPTION OF THE PREFERRED EMBODIMENTS

Embodiments of the present disclosure will be described below with reference to the accompanying drawings. In the present disclosure, a multifunction peripheral capable of executing a job related to, for example, copying, faxing, or e-mail transmission in a single housing will be described as one form of a display processing apparatus or an image processing apparatus in which the display processing apparatus is mounted. The embodiments described below are presented as examples for explaining the present disclosure, and the technical scope of the embodiments as recited in the appended claims is not limited by the following description.

### 1. First Embodiment

A first embodiment corresponds to a mode of determining setting history information whose necessity is low for execution of a job, and deciding on order of display by excluding such setting history from pieces of setting history information to be displayed.

### 1.1 Functional Configuration

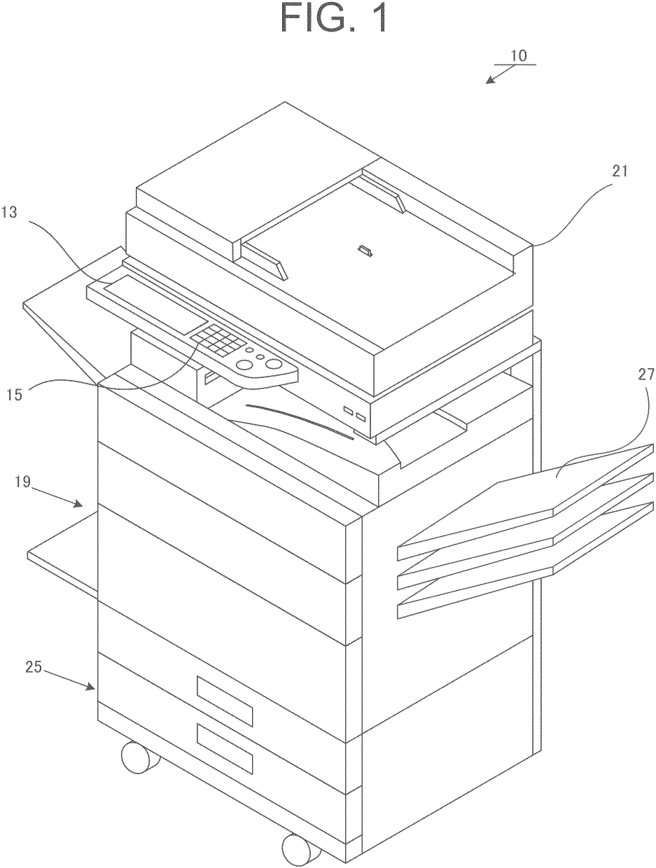

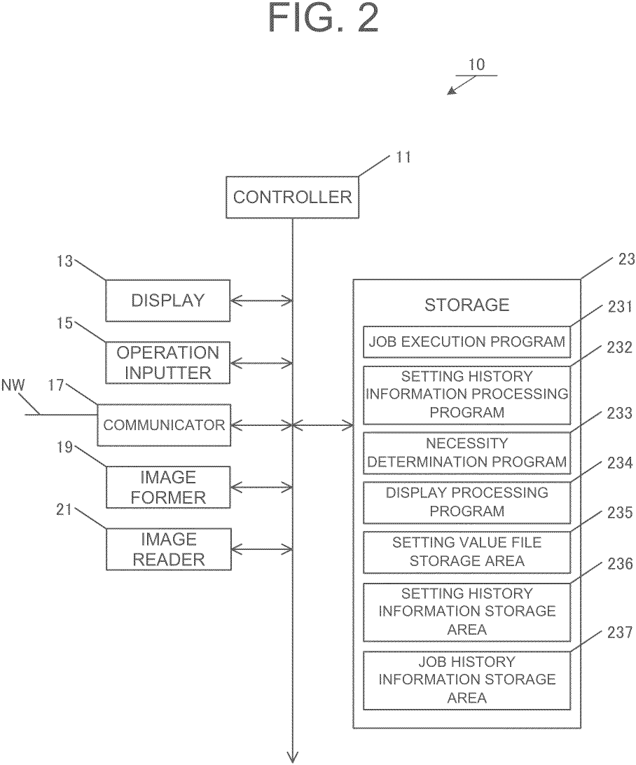

A functional configuration of a multifunction peripheral 10 according to the first embodiment will be described with reference to FIGS. 1 and 2. FIG. 1 is an external perspective view which schematically illustrates an overall configuration of the multifunction peripheral 10. FIG. 2 is a functional configuration diagram of the multifunction peripheral 10. The multifunction peripheral 10 includes a controller 11, a display 13, an operation inputter 15, a communicator 17, an image former 19 and an image reader 21 as an image processor, and a storage 23.

The controller 11 performs overall control of the multifunction peripheral 10. The controller 11 is configured from, for example, one or more arithmetic devices (e.g., central processing units [CPUs]). The controller 11 reads and executes various programs stored in the storage 23, thereby implementing functions thereof.

The display 13 displays various kinds of information to a user or the like. The display 13 can be composed of a display device such as a liquid crystal display (LCD) or an organic electro-luminescence (EL) display.

The operation inputter 15 receives input of information by the user or the like. The operation inputter 15 can be configured from, for example, a hard key (e.g., a numeric keypad), buttons, and the like. The operation inputter 15 can be configured as a touch panel that allows input via the display 13. In this case, for example, a common method such as a resistive method, an infrared method, an electromagnetic induction method, or a capacitive sensing method may be employed as an input method for the touch panel.

The communicator 17 is provided with either of or both of wired and wireless interfaces to communicate with another device via a network (NW) such as a local area network (LAN), a wide area network (WAN), the Internet, a telephone line, or a fax line.

The image former 19 forms an image based on image data on paper as a recording medium. The image former 19 feeds paper from a paper feeder 25, forms an image based on image data on the paper, and then discharges the paper to a paper discharger 27. The image former 19 can be composed of, for example, a laser printer using an electrophotographic method. In this case, the image former 19 forms an image by using toners supplied from toner cartridges (not illustrated) corresponding to toner colors (e.g., cyan, magenta, yellow, and black).

The image reader 21 scans and reads a document image to be read, and the image data is thus generated. The image reader 21 may be configured as a scanner device including an image sensor such as a charge coupled device (CCD) or a contact image sensor (CIS). The configuration of the image reader 21 is not limited as long as the image reader 21 is configured to generate image data by reading a reflected light image from a document image with an image sensor.

The storage 23 stores therein various kinds of data and various programs necessary for operation of the multifunction peripheral 10. The storage 23 can be configured from, for example, storage devices such as a random-access memory (RAM), a hard disk drive (HDD), a solid state drive (SSD), and a read-only memory (ROM).

In the first embodiment, the storage 23 stores a job execution program 231, a setting history information processing program 232, a necessity determination program 233, and a display processing program 234, and reserves a setting value file storage area 235, a setting history information storage area 236, and a job history information storage area 237.

The job execution program 231 is a program that the controller 11 reads in order to perform processing associated with execution of each function of copying, faxing, e-mail transmission, etc., on a job-by-job basis. The controller 11 that has read the job execution program 231 executes a job by controlling the display 13, the operation inputter 15, the communicator 17, the image former 19, the image reader 21, and the like. Further, the controller 11 that has read the job execution program 231 can execute various jobs on the basis of setting values included in a setting value file of setting history information to be described later.

The setting history information processing program 232 is a program that the controller 11 reads when, for example, acquisition of a setting value or the like pertaining to job execution, generation of setting history information, and various kinds of processing in response to the setting history information are to be performed. The controller 11 that has read the setting history information processing program 232 acquires setting values pertaining to job execution, and generates a setting value file containing the setting values. Then, the controller 11 stores the generated setting value file in the setting value file storage area 235. In addition, the controller 11 generates setting history information by associating the setting value file with identification information (e.g., job ID) for identifying to which job the setting history information is related. Then, the controller 11 stores, as a setting history, the generated setting history information in the setting history information storage area 236.

The necessity determination program 233 is a program that the controller 11 reads when, for example, the number of pieces of setting history information to be displayed on the display 13 has reached the number of enabled displays on the display 13, or when an instruction to change the display of the setting history information (i.e., the screen) has been received from the user. The controller 11 that has read the necessity determination program 233 determines the necessity of the setting history information for execution of a job. On the basis of the necessity that has been determined, the controller 11 decides on display order in which the pieces of setting history information are to be displayed on the display 13 (i.e., a setting history information display screen).

The necessity according to the present disclosure refers to an index used to evaluate the needs (demand, request), importance, or a degree of necessity of the setting history information to be relied upon in executing a job, in terms of high or low of a level (degree). The necessity according to the present disclosure can be determined on the basis of, for example, a specific numerical evaluation such as a number of use of each piece of setting history information that is applied in execution of a job, or a relative evaluation such as whether the state indicated by the setting history information matches with a particular condition. If the controller 11 determines that the necessity of specific setting history information is low for execution of a job, the controller 11 excludes the specific setting history information from pieces of setting history information related to decision on order of display. Processing regarding determination of the necessity will be described later.

The display processing program 234 is a program that the controller 11 reads when displaying, on the display 13, a display screen that displays pieces of setting history information as setting histories; a setting screen for receiving input of various setting values pertaining to job execution; a basic screen (a home screen) that displays the setting screens in a switchable manner; or a login screen for user authentication, for example.

The setting value file storage area 235 is a storage area for storing the setting value file generated by the controller 11 that has read the setting history information processing program 232. The setting values include, for example, setting values of a color mode, a resolution, a format, a density, and the like, set by the user, and setting values such as a device default value held by the device itself. As the controller 11 that has read the job execution program 231 executes a job by using the setting value file associated with the setting history information, the controller 11 can reproduce the job based on the relevant setting history information.

The setting history information storage area 236 is a storage area for storing pieces of setting history information generated by the controller 11. Each of the pieces of setting history information stored in the setting history information storage area 236 is read as appropriate during processing of display as the setting history, or when executing a job based on the relevant setting history information.

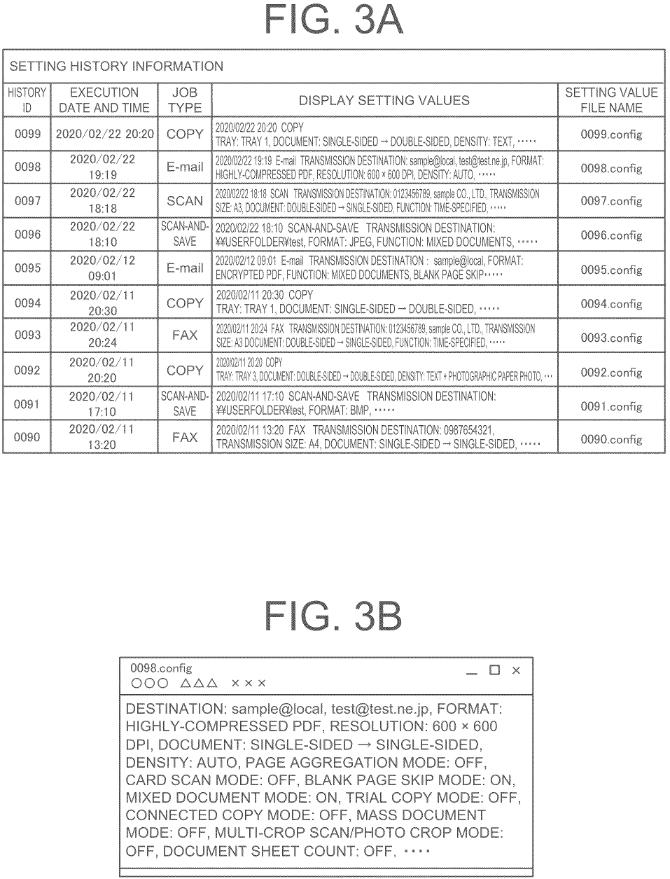

The setting history information according to the present disclosure will now be described. FIG. 3A is a table illustrating a configuration example of a data structure of the setting history information stored in the setting history information storage area 236. FIG. 3B is a diagram illustrating a configuration example of a data structure of a setting value file associated with the setting history information of FIG. 3A.

Pieces of setting history information exemplified in FIG. 3A each include a history ID, execution date and time, a job type, display setting values, and a setting value file name.

The history ID is identification information for uniquely identifying the setting history information. The history ID is assigned to each piece of setting history information generated. As exemplified in FIG. 3A, the history ID may be a serial number, or may include a predetermined character string, symbols, or the like. The execution date and time indicates the date and time of the execution of a job. The job type indicates the type of the executed job (e.g., Copy, E-mail, etc.). The display setting values indicate a part of the setting values (contents) to be displayed on the display screen. The setting value file name represents the file name of the setting value file associated with the relevant setting history information.

For example, the setting history information pertaining to history ID “0099” indicates setting history information related to a job whose job type is “Copy”, which was executed on “2020/02/22 20:20”. The job is a copy job executed on the basis of the setting values included in a file with the setting value file name “0099. config”, and represents an example in which the setting values (items) such as “Tray: Tray 1, Document: Single-sided → Double-sided, Density: Text, . . . ” are set as the display setting values. Note that the display setting values set for each history ID are merely examples, and the setting values displayed on the display screen are not limited to those illustrated in FIG. 3A.

FIG. 3B shows an example of a data structure of a setting value file named “0098.config” that is associated with history ID “0098.” The setting value file exemplified in FIG. 3B can be configured as a text file or binary data storing, for example, setting values pertaining to job execution, such as “Destination: sample@local, test@test.ne.jp, Format: Highly-compressed PDF, Resolution: 600 × 600 dpi, Document: Single-sided → Single-sided, Density: Auto, Page aggregation mode: off, Card scan mode: off, Blank page skip mode: on, Mixed document mode: on, Trial copy mode: off, Connected copy mode: off, Mass document mode: off, Multi-crop scan/Photo crop mode: off, Document sheet count: off, ...”. In executing a job based on the setting history information, the controller 11 executes the job related to the relevant setting history by using the setting values stored in the relevant setting value file. Further, when processing related to the job is finished, the controller 11 stores the setting values that have been used for the job execution in a setting value file.

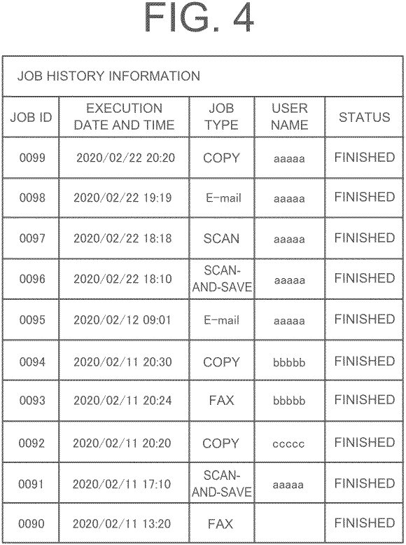

Returning to FIG. 2, the job history information storage area 237 is a storage area for storing a job execution record as a piece of job history information. The job history information according to the present disclosure will now be described. FIG. 4 is a table illustrating a configuration example of a data structure of pieces of job history information stored in the job history information storage area 237.

The pieces of job history information exemplified in FIG. 4 each include a job ID, execution date and time, a job type, a user name, and a status. The job ID, the execution date and time, and the job type are the same items as those included in the setting history information illustrated in FIG. 3A, and have the same contents as those of FIG. 3A. The user name indicates the name of the user who has executed the job. The status indicates the processing status of the job.

For example, the job history information pertaining to job ID “0098” indicates job history information related to a job whose job type is “E-mail”, which was executed on “2020/02/22 19:19”. Further, the job indicates that an execution instruction has been input by a user with the user name “aaaaa”, and the status of the job is “finished”.

Unlike the setting history information, the job history information is information in which a job execution history is recorded. The job history information can be generated at an arbitrary timing, such as when a job is registered, after completion of a job, or after the setting history information has been generated.

### 1.2 Flow of Processing

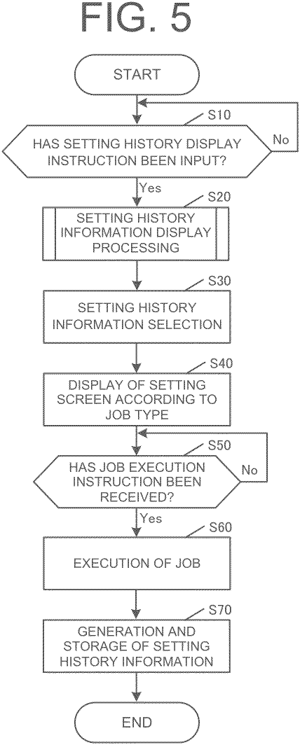

Next, a flow of processing according to the first embodiment will be described. FIG. 5 is a flowchart illustrating processing related to execution of a job using setting history information. The processing described below is processing executed by the controller 11 as the controller 11 reads the job execution program 231, the setting history information processing program 232, the necessity determination program 233, the display processing program 234, and the like.

First, the controller 11 determines whether an instruction to display pieces of setting history information by the user is received (step S10). An instruction to display pieces of setting history information can be received, for example, via the home screen or the setting screen according to each job type, which will be described later.

If it is determined that an instruction to display pieces of setting history information is received, the controller 11 reads the necessity determination program 233, the display processing program 234, and the like. The controller 11 which has read these programs executes display processing related to setting history information, which will be described later, and displays pieces of the relevant setting history information on the display 13 (step S10; Yes → step S20). If it is determined that no instruction to display pieces of setting history information has been input, the controller 11 waits until an instruction to display pieces of setting history information is input (step S10; No). If no instruction to display pieces of setting history information is input, but an instruction to display a setting screen pertaining to a specific job type is input via the home screen, the controller 11 may shift the processing to step S40 to display the relevant setting screen on the display 13.

Next, the controller 11 receives selection of a piece of setting history information by the user (step S30).

When the controller 11 receives selection of the piece of setting history information, the controller 11 reads the setting value file associated with the selected setting history information, and displays a setting screen according to the job type (step S40).

The controller 11 determines whether an instruction to execute a job has been received via the setting screen (step S50). If the controller 11 determines that an instruction to execute a job has been received, the controller 11 executes the job (step S50; Yes → step S60). If it is determined that no instruction to execute a job has been input, the controller 11 waits until an instruction to execute a job is input (step S50; No).

Then, the controller 11 generates new setting history information related to the job executed in step S60. The controller 11 then stores the generated setting history information in the setting history information storage area 236, and ends the processing (step S70). Here, a mode of generating and storing setting history information after execution of a job has been described. However, the timing of generating and storing the setting history information is not limited to the above, and may be a timing when an instruction to execute a job is received in step S50, or during job execution.

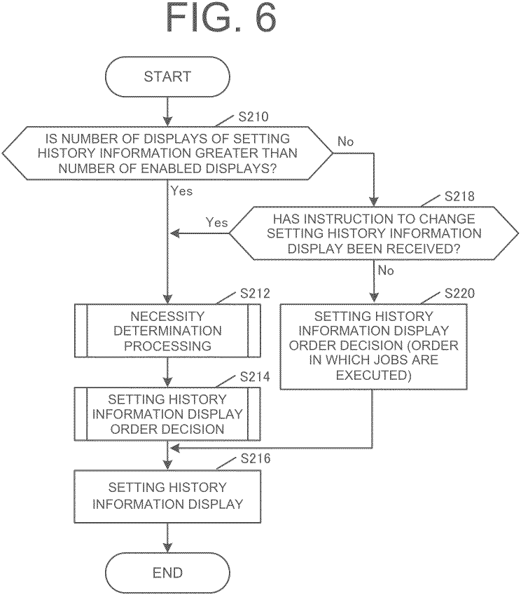

Next, setting history information display processing related to step S20 of FIG. 5 will be described referring to FIGS. 6, 7, 8, and 9.

FIG. 6 is a flowchart illustrating an overall flow of the setting history information display processing. The controller 11 executes the present processing by reading the display processing program 234, the necessity determination program 233, and the like.

In step S10 of FIG. 5, when the controller 11 receives a setting history information display instruction, the controller 11 determines whether the number of pieces of setting history information to be displayed exceeds an upper limit of the number of enabled displays on the display 13 (step S210). The number of pieces of setting history information to be displayed may be the total number of pieces of setting history information stored in the setting history information storage area 236, or may be the number of histories for display that has been set in advance. Incidentally, when the number of histories for display is set in advance, it is possible to make the values of the set number and the number of enabled displays the same as each other. Further, the number of enabled displays on the display 13 represents the number of pieces of setting history information that can be displayed on a screen of the display 13. The number of enabled displays can be set as appropriate on the basis of the screen size, or a screen configuration and the like of the display 13. Also, the number of enabled displays may be the number of displays of pieces of setting history information that can be displayed on the screen at one time, or may be the number of displays including the setting history information which can be displayed as a result of a screen transition made by a screen transition technique (e.g., a scroll bar or a screen operation such as a swipe operation and the like) provided on the screen.

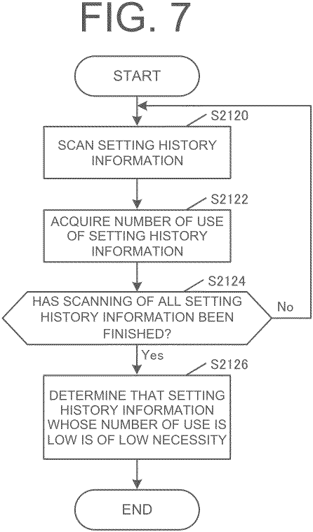

If it is determined that the number of pieces of setting history information to be displayed exceeds an upper limit of the number of enabled displays on the display 13, the controller 11 executes processing of determination related to necessity (step S210; Yes → step S212). The processing of determination related to necessity will be described with reference to FIG. 7.

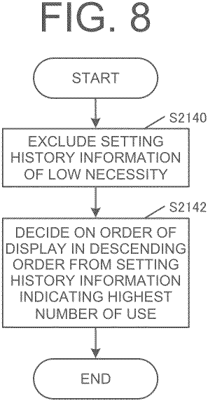

On the basis of a result of the necessity determination processing, the controller 11 decides on setting history information display order (step S214). Processing of deciding on order of display of pieces of setting history information will be described with reference to FIG. 8.

Then, the controller 11 displays, on the basis of the decided order of display for pieces of setting history information, the pieces of setting history information on the display 13, and ends the processing (step S216).

Incidentally, if it is determined that the number of pieces of setting history information to be displayed is less than the number of enabled displays on the display 13, the controller 11 determines whether an instruction to change the display of the pieces of setting history information has been received from the user via the home screen, etc. (step S218).

If it is determined that an instruction to change the display of the pieces of setting history information is received, the controller 11 executes the processing of step S212 and the subsequent steps (step S218; Yes → step S212). Meanwhile, if it is determined that no instruction to change the display of the pieces of setting history information is received, the controller 11 decides to display the pieces of setting history information in chronological order corresponding to the order in which the jobs are executed (step S218; No → step S220). Then, the controller 11 displays, on the basis of the decided order of display (chronological order) for the pieces of setting history information, the pieces of setting history information on the display 13, and ends the processing (step S220 → step S216).

Next, the necessity determination processing related to step S212 of FIG. 6 will be described with reference to a flowchart of FIG. 7. In the first embodiment, a mode of applying a number of use of each piece of setting history information will be described as a numerical evaluation criterion for determining the necessity.

The controller 11 starts scanning of pieces of setting history information stored in the setting history information storage area 236 (step S2120).

The controller 11 acquires a number of use of each piece of setting history information (step S2122). The number of use of each piece of setting history information may be stored in the form of being stored in the setting history information used to execute the job, or may be stored in the form of being stored in the setting value file associated with the relevant setting history information, or the job history information.

Next, the controller 11 determines whether or not scanning of all pieces of the setting history information has been finished (step S2124). If it is determined that scanning of all pieces of the setting history information has been finished, the controller 11 specifies the setting history information whose number of use is low for execution of a job, and determines that the necessity of such setting history information is low (step S2124; Yes → step S2126). Then, the controller 11 ends the processing.

Incidentally, the setting history information whose number of use is low may include setting history information whose number of use is zero. Also, in evaluating whether the number of use is high or low, for example, the setting history information whose number of use is below a specific number of use, such as zero times, once, twice,... N times, may be evaluated as the setting history information whose number of use is low. Meanwhile, in a case where the number of use of the setting history information is below a predetermined ratio relative to the highest number of use, it is also possible to evaluate such setting history information as the setting history information whose number of use is low. For example, if the predetermined ratio is set to 10%, and the highest number of use is assumed to be 12 times, it is also possible for the controller 11 to evaluate the setting history information whose number of use is less than 1.2 times as the setting history information whose number of use is low.

Meanwhile, if it is determined that scanning of all pieces of the setting history information has not been finished, the controller 11 returns the processing to step S2120, and starts scanning of the next piece of setting history information (step S2124; No → step S2120).

Next, the processing of deciding on the order of display of pieces of setting history information related to step S214 of FIG. 6 will be described with reference to a flowchart of FIG. 8.

Having received a result of the necessity determination processing related to step S212 of FIG. 6, the controller 11 excludes the setting history information whose necessity is determined as being low from the pieces of setting history information related to decision on order of display (step S2140).

Then, the controller 11 decides on the order of display, for the remaining pieces of setting history information in which the setting history information whose necessity is low is excluded, in descending order from the setting history information indicating the highest number of use, and ends the processing (step S2142).

### 1.3 Operation Example

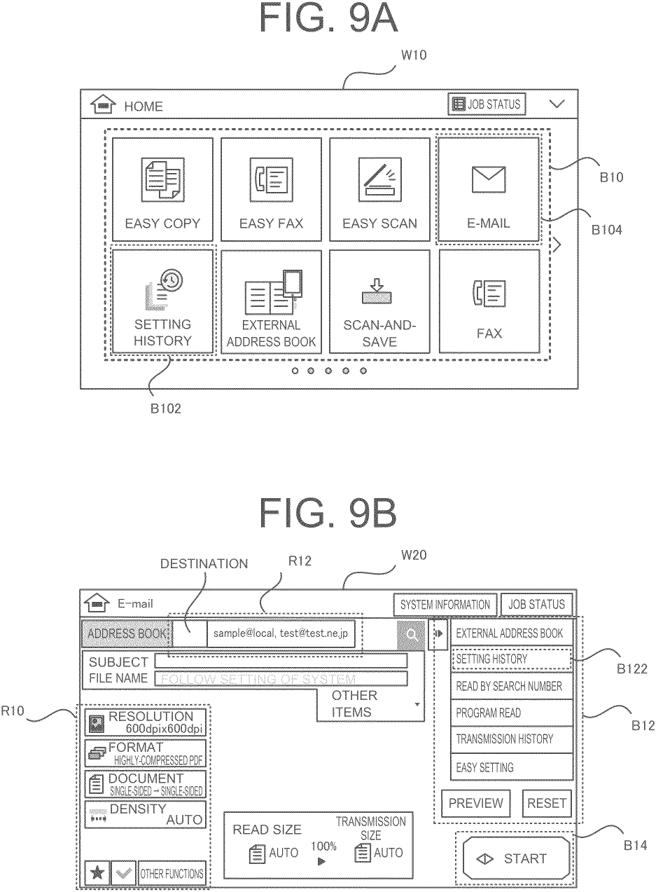

Next, an operation example according to the first embodiment will be described. FIG. 9A is a diagram illustrating a configuration example of a home screen W10 on which an instruction to display pieces of setting history information can be received. FIG. 9B is a diagram illustrating a configuration example of a setting screen W20 related to e-mail transmission as an example of a setting screen on which an instruction to display pieces of setting history information can be received.

The home screen W10 exemplified in FIG. 9A is a basic screen that is displayed on the display 13 when, for example, power is turned on, or the multifunction peripheral is in a standby mode, or recovered from a sleep mode, and receives operation input from the user. The home screen W10 includes mode selection buttons B10.

The mode selection buttons B 10 are buttons that receive selection of an operation mode of the multifunction peripheral 10. FIG. 9A shows a configuration example in which as selectable operation mode buttons, an Easy Copy button, an Easy Fax button, an Easy Scan button, an E-mail button B 104, a Fax button, a Scan-and-Save button, an external address book button, and a setting history button B102 are provided. Here, “Easy” in “Easy Copy”, etc., is intended as the function in which a part of the setting values (setting items) that can be selected in normal copy are made impossible to be set on purpose (or made fixed default settings), so that an operation related to execution of the job is simplified. For example, the user can easily execute a job related to copy without making any complicated settings by selecting the Easy Copy as the job. The example of button configuration illustrated in FIG. 9A is merely an example, and the configuration can be changed as appropriate via, for example, a system setting screen or the like (not illustrated).

The setting history button B102, which is included in the mode selection buttons B10, is a button which receives an instruction to display pieces of setting history information. When an instruction of selecting the setting history button B102 is received, the controller 11 can execute the processing related to step S20 of FIG. 5, and perform the setting history information display processing.

The setting screen W20 related to e-mail transmission exemplified in FIG. 9B can be displayed on the display 13 by selecting, for example, the E-mail button B104 included in the mode selection buttons B10 on the home screen W10. The setting screen W20 is a setting screen which receives input or selection, etc., of setting values pertaining to e-mail transmission. The setting screen W20 includes a setting value display area R10, a destination display area R12, processing selection buttons B 12, and a start button B14.

The setting value display area R10 is a display area for displaying the setting values pertaining to e-mail transmission. The setting value display area R10 displays a device default value pertaining to e-mail transmission, a setting value based on the setting value file read from the setting value file storage area 235 by the controller 11, and the like. As the setting values (items) that can be set, FIG. 9B shows an example in which four types of setting values (items), which are Resolution (600 dpi x 600 dpi), Format (Highly-compressed PDF), Document (Single-sided → Single-sided), and Density (Auto), are displayed. The setting values (items) exemplified in the setting value display area R10 of FIG. 9B correspond to the setting history information of history ID “0098” exemplified in FIG. 3A.

The destination display area R12 is a display area for displaying a transmission destination of the e-mail transmission. FIG. 9B shows an example in which the transmission destination “sample@local, test@test.ne.jp” based on the setting history information of history ID “0098” exemplified in FIG. 3A is displayed.

The processing selection buttons B12 are buttons which receive selection of processing (action) desired by the user. The processing selection buttons B 12 include a setting history button B122, in addition to selection buttons which receive selection of various kinds of processing such as an external address book button, a read-by-search-number button, a program read button, a transmission history button, and an easy setting button. The setting history button B122 receives an instruction to display pieces of setting history information likewise the setting history button B102 on the home screen W10. When an instruction of selecting the setting history button B122 is received, the controller 11 can execute the processing related to step S20 of FIG. 5, and perform the setting history information display processing.

The start button B14 is a button which receives an instruction to execute an e-mail transmission. When the start button B 14 is selected by the user, the controller 11 executes the e-mail transmission to the transmission destination displayed in the destination display area R12.

Next, an operation example related to display control for setting history information will be described. In order to facilitate the understanding, first, with respect to the order of display, an operation example in which pieces of setting history information are displayed in chronological order according to the order in which the jobs are executed will be described (corresponding to the processing of step S220, which is performed when step S218 of FIG. 6 is “No”). Next, an operation example related to display of setting history information that is decided by applying the necessity determination processing will be described (corresponding to the processing of step S214, which is performed subsequent to step S212 of FIG. 6).

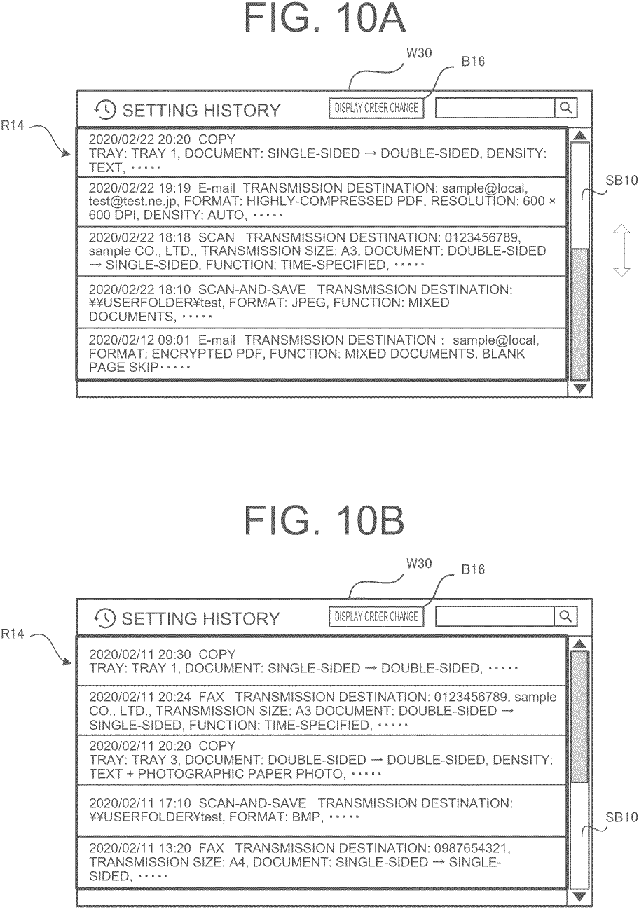

FIGS. 10A and 10B show a configuration example of a setting history display screen W30 displayed by the controller 11 when the number of pieces of setting history information to be displayed is less than the number of enabled displays on the display 13, and when no instruction to change the display of the pieces of setting history information is received.

The setting history display screen W30 includes a setting history information display area R14, a slider bar SB10, and a display order change button B16. The setting history information display area R14 can be configured as a display area for displaying pieces of setting history information pertaining to respective history IDs such that the setting history information can be selected. In the example illustrated in FIG. 10A, pieces of setting history information pertaining to history ID “0099” to history ID “0095” are displayed in chronological order according to the order in which the jobs are executed (see FIG. 3).

The slider bar SB10 is configured to be able to slide toward one end side of the setting history information display area R14. The slider bar SB10 receives an instruction to display pieces of setting history information pertaining to history ID “0094” to history ID “0090”, which are hidden from display, in the setting history information display area R14 of FIG. 10A. In this case, for example, by moving the slider bar SB 10 downward, pressing a down-arrow button, or performing an upward flicking operation within the setting history information display area R14, the pieces of setting history information pertaining to history ID “0094” to history ID “0090” can be displayed.

FIG. 10B shows an example in which an area that is hidden from display in FIG. 10A is displayed by operating the slider bar SB10. That is, FIG. 10B shows an example in which the pieces of setting history information pertaining to history ID “0094” to history ID “0090” exemplified in FIG. 3A are displayed in the setting history information display area R14.

The display order change button B 16 is a button that receives a display order change instruction to change the order of display of the pieces of setting history information being displayed in the setting history information display area R14. As the display order change button B16 is selected, the controller 11 executes the processing from step S212 to step S214 of FIG. 6, and changes the order of display of the pieces of setting history information on the basis of order of display that is decided by applying the necessity determination processing.

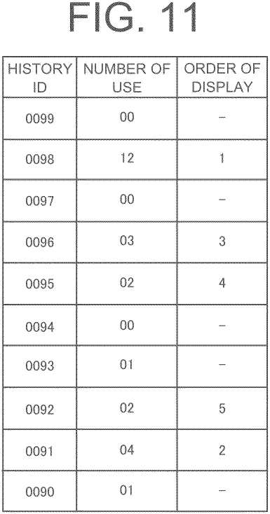

FIG. 11 is a table illustrating a configuration example of a display order decision table which summarizes the order of display of pieces of setting history information (step S214 of FIG. 6), which is decided on the basis of a necessity determination result (step S212 of FIG. 6).

History ID, which is the leftmost item in the table, indicates each history ID exemplified in FIG. 3A. Number of use, which is the item at the center of the table, indicates the number of use of each piece of setting history information acquired by the controller 11 in step S2122 of FIG. 7. Display order, which is the rightmost item in the table, indicates order of display of the pieces of setting history information that is decided on the basis of the flowchart of FIG. 8. The operation example of FIG. 11 illustrates a case where, as a result of deciding that setting history information whose number of use is equal to or less than once is of low necessity, and thus lowering the order of display of such setting history information, pieces of the corresponding setting history information (history ID “0099”, history ID “0097”, history ID “0094”, history ID “0093”, and history ID “0090”) are excluded from a target of setting history information related to decision on order of display.

For the remaining pieces of setting history information, which are the setting history information whose necessity is low is excluded, the controller 11 decides on the order of display in descending order from the setting history information indicating the highest number of use. FIG. 11 illustrates an example in which the order of display is decided in the order of the most frequently used history, i.e., history ID “0098” (used 12 times), history ID “0091” (used four times), history ID “0096” (used three times), history ID “0095” (used twice), and history ID “0092” (used twice). Note that FIG. 11 illustrates an example in which the order of display is decided such that for history ID “0095” and history ID “0092” indicating the same number as the number of use (i.e., used twice), the setting history information with the newer execution date and time (history ID “0095”) comes at an upper position. The handling of pieces of setting history information having the same value as the number of use, etc., used in the numerical evaluation criterion will be described later.

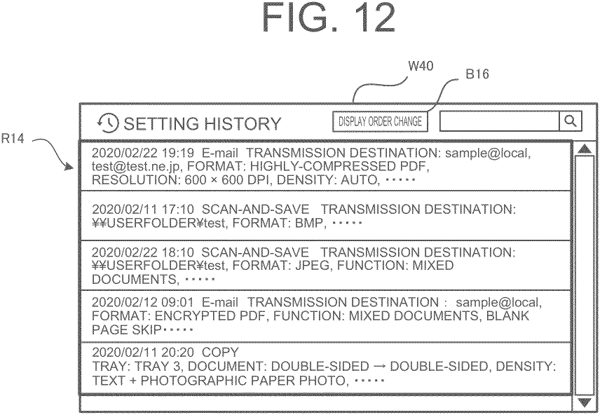

FIG. 12 shows a configuration example of a setting history display screen W40 which displays the pieces of setting history information in descending order from the one indicating the highest number of use according to the display order table exemplified in FIG. 11. The example of a screen configuration of the setting history display screen W40 may be of the same configuration as the setting history display screen W30 exemplified in FIG. 10, and thus description thereof is omitted.

As indicated in FIG. 12, from the setting history information displayed on the setting history display screen W40, pieces of setting history information whose necessity is low (i.e., history ID “0099”, history ID “0097”, history ID “0094”, history ID “0093”, and history ID “0090”) are excluded from a target of display. On the setting history display screen W40, pieces of setting history information are displayed in descending order from the setting history information whose number of use is the highest, in other words, the necessity is high. Therefore, the user can easily ascertain the setting history information whose necessity is high for execution of a job.

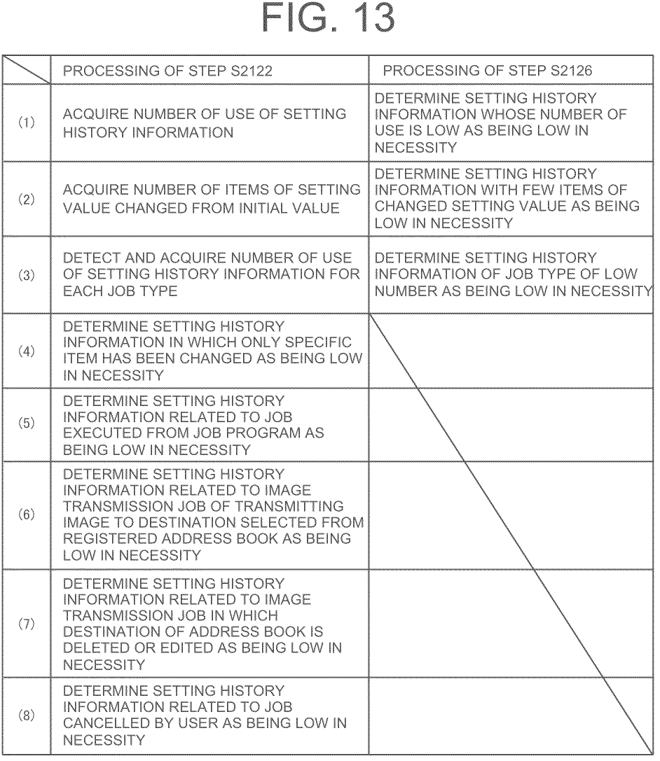

Regarding Evaluation Criteria Applicable to Necessity Determination In step S212 of FIG. 6, and steps S2122 and S2126 of FIG. 7 which describe the processing of the aforementioned step S212, determination related to necessity can also be performed by a determination method using evaluation criteria exemplified in FIG. 13.

Determination method (1) is a method of determining the setting history information whose number of use is the lowest as being low in necessity, as described above.

Determination method (2) is a method of acquiring, in step S2122 of FIG. 7, the number of items of setting value changed from the initial value, and determining, in step S2126, the setting history information with the fewest items of changed setting value as being low in necessity. If changes from the initial value are few, it can be judged that the necessity of such setting history information is low.

Determination method (3) is a method of acquiring, in step S2122 of FIG. 7, a number of use of the setting history information for each job type, and determining, in step S2126, the setting history information of the job type of the lowest number of use as being low in necessity. If the number of use in terms of a job (type) is low, it can be judged that the necessity of such setting history information is low.

Determination method (4) is a method of determining, in step S2122 of FIG. 7, that the setting history information in which only a specific item, which is to be changed for each use of the setting history information as a change history, such as the number of copies, has been changed is of low necessity. Even if the setting history information is stored, it is highly likely that the setting contents will be changed, and it can be judged that the necessity of keeping the setting history information is low.

Determination method (5) is a method of determining, in step S2122 of FIG. 7, the setting history information related to a job which has been executed from a job program as being low in necessity. The job program according to the present disclosure pertains to a technology for manually storing the settings related to a job permanently, and indicates a batch setting in which the settings related to job processing are registered in a batch. In the use case where a regular job is repeatedly executed, the user can call and execute the job program, thereby enabling the setting values pertaining to the job to be set in a batch. Therefore, the number of setting steps when the job is to be executed can be reduced. As can be seen, since the setting values pertaining to a job executed from a job program are already registered in the job program, it can be judged that the necessity of keeping the setting history information is low.

Determination method (6) is a method of determining, in step S2122 of FIG. 7, that the setting history information related to an image transmission job, such as an e-mail transmission job or a fax job in which a destination selected from a registered address book is used as the transmission destination, is of low necessity. Since the destinations are registered in the address book, and selection of a destination is easy, it can be judged that the necessity of keeping the setting history information related to the image transmission job is low.

Determination method (7) is a method of determining, in step S2122 of FIG. 7, the setting history information related to an image transmission in which the destination of the registered address book is corrected or deleted as being low in necessity. Since such setting history information is not based on the destination of the address book originally registered, it can be judged that the necessity of keeping the setting history information is low.

Determination method (8) is a method of determining, in step S2122 of FIG. 7, that the setting history information (a cancellation history) related to a job canceled by the user due to, for example, a jam caused by a paper jam or indication of an error code is of low necessity. Since such setting history information is one related to a job canceled by the user, it can be judged that the necessity of keeping the setting history information is low. In this case, the order of display can be decided for pieces of setting history information in which the setting history information related to the canceled job is excluded (i.e., pieces of setting history information which are not canceled).

As described above, according to the first embodiment, setting history information whose necessity is low for execution of a job is determined, and the order of display is decided by excluding such setting history information from pieces of setting history information to be displayed. Therefore, the setting history information that the user wishes to use can be accurately displayed.

### 2. Second Embodiment

A second embodiment corresponds to a mode of displaying setting history information pertaining to a user who has been authenticated as a login user, in response to user authentication when a user authentication function is enabled.

### 2.1 Functional Configuration

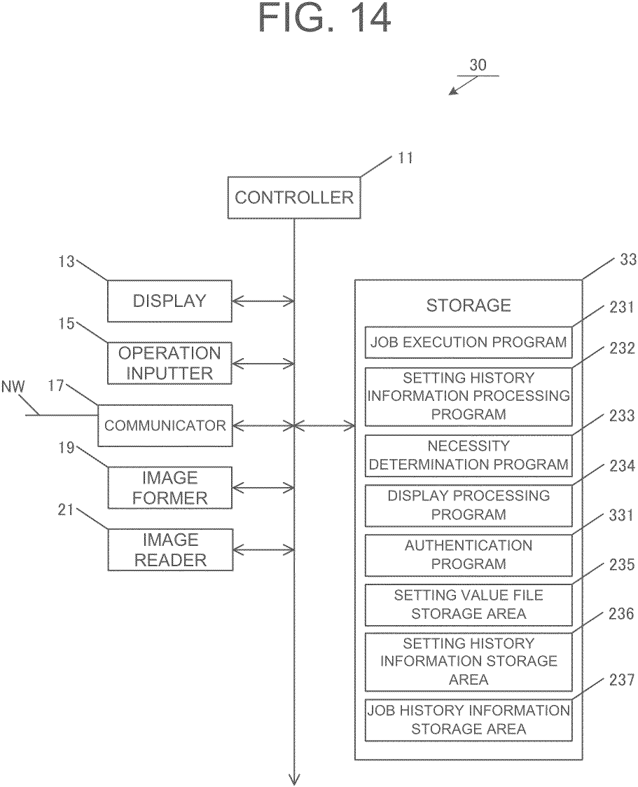

FIG. 14 is a functional configuration diagram of a multifunction peripheral 30 according to a second embodiment. The multifunction peripheral 30 includes a storage 33 in place of the storage 23 of the multifunction peripheral 10 according to the first embodiment. In the following description, the same configuration as that of the multifunction peripheral 10 according to the first embodiment may be denoted by the same reference numerals to omit description of the same configuration.

The storage 33 includes, in addition to the constituent elements of the storage 23, an authentication program 331. The authentication program 331 is a program that a controller 11 reads in authenticating the user.

The controller 11 receives, for example, authentication information related to user authentication such as a login user name and a login password, when the user authentication function is enabled, and performs user authentication. When a login operation is performed with administrator rights, the controller 11 authenticates an administrative user by requesting input of administrator information, or referring to registration information as the administrative user, as necessary.

The controller 11 can perform the user authentication by comparing a combination of the login user name and the login password input by the user with a combination of the login user name and the login password registered in the device itself in advance. The user authentication may be carried out by an authentication server installed outside separately. In this case, the authentication server holds the login user name and the login password for user authentication.

Incidentally, besides a combination of the login user name and the login password, user authentication can also be performed by, for example, a combination of an identification number, a registration number, or the like, and a login password; possession authentication using a token, a key, an integrated circuit (IC) card, a smartphone, and the like; or biometric authentication such as fingerprint authentication and face authentication.

### 2.2 Flow of Processing

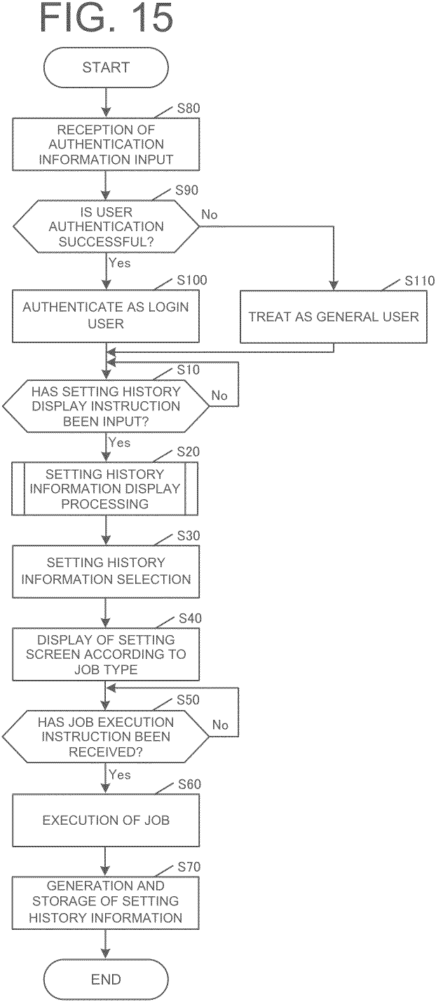

Next, a flow of processing according to the second embodiment will be described. FIG. 15 is a flowchart illustrating processing related to execution of a job using setting history information. The processing described below is processing executed by the controller 11 as the controller 11 reads a job execution program 231, a setting history information processing program 232, a necessity determination program 233, a display processing program 234, the authentication program 331, and the like.

The processing to be described referring to FIG. 15 is obtained by adding processing related to user authentication to the processing described referring to FIG. 5 of the first embodiment. Therefore, the same processing is denoted by the same step number, and description thereof is omitted.

The controller 11 receives input of authentication information related to a user who attempts to log into the multifunction peripheral 30 via a user authentication screen to be described later (step S80).

Next, the controller 11 performs user authentication on the basis of the received authentication information. If the user authentication is successful, the controller 11 authenticates the user from who the input of authentication information is received as a login user (step S90; Yes → step S 100). Meanwhile, if the user authentication is not successful, the controller 11 treats the user from who the input of authentication information is received as a general user who temporarily uses the multifunction peripheral 30 (step S90; No → step S110).

Next, the controller 11 executes processing related to step S10 to step S70 described referring to FIG. 5.

Incidentally, internal processing of setting history information display processing related to step S20 of FIG. 15 can be made the same as the processing described referring to FIG. 6. Thus, description thereof is omitted.

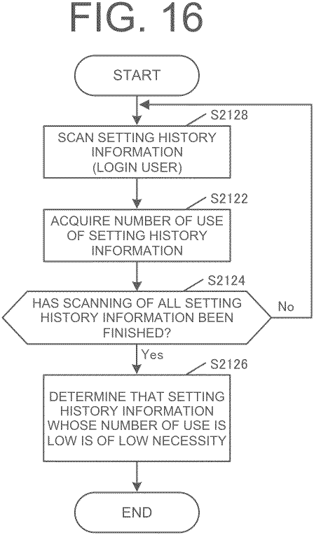

FIG. 16 is a flowchart illustrating processing of determination related to necessity according to the second embodiment. The processing to be described referring to FIG. 16 is processing obtained by replacing step S2120 of the processing that has been described referring to FIG. 7 of the first embodiment with step S2128.

When necessity determination processing corresponding to step S212 of FIG. 6 is started, the controller 11 starts, on the basis of setting history information stored in a setting history information storage area 236, scanning of pieces of setting history information corresponding to jobs executed in the past by a login user who has been authenticated in step S100 of FIG. 15 (step S2128).

In other words, in the second embodiment, only the pieces of setting history information pertaining to the authenticated login user are treated as a target of display processing. Since the processing related to step S2122 to step S2126 subsequent to step S2128 can be made the same as the processing described referring to FIG. 7, description thereof is omitted.

Meanwhile, if the user is to be treated as a general user who temporarily uses the multifunction peripheral 30 (step S90 of FIG. 15; No → step S110), the controller 11 performs, as the processing corresponding to step S2128, scanning of all pieces of the setting history information as a target of display, as in step S2120 of FIG. 7.

### 2.3 Operation Example

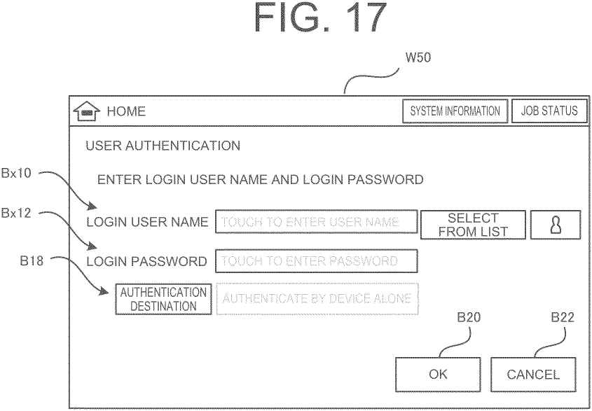

Next, an operation example according to the second embodiment will be described. FIG. 17 is a diagram illustrating a configuration example of an authentication screen W50 which receives input of authentication information such as the login user name and the login password. A user who attempts to use the multifunction peripheral 30 can log into the multifunction peripheral 30 as the login user by performing user authentication via the authentication screen W50.

The authentication screen W50 exemplified in FIG. 17 includes a login user name input box Bx10, a login password input box Bx12, an authentication destination specification button B18, an OK button B20, and a cancel button B22.

The login user name input box Bx10 is an input box which receives input of a login user name. A user attempting to log into the multifunction peripheral 30, or an administrative user attempting to log in with administrator rights enters the login user name in the login user name input box Bx10. Note that the login user name can be selected from a user name list (not illustrated) by selecting a “Select from List” button disposed adjacent to the login user name input box Bx10.

The login password input box Bx12 is an input box which receives input of a login password corresponding to the login user name. The user attempting to log into the multifunction peripheral 30 enters the login password together with the input of the login user name.

The authentication destination specification button B18 is a button which receives specification of a user authentication destination. The authentication destination may be the device alone, or an authentication server or the like separately provided on a network, for example, can be specified as the authentication destination. When authentication by the device alone is selected as the authentication destination, the controller 11 authenticates the user by comparing the entered login user name and login password with the authentication information prepared in advance (e.g., a combination of the user name and the password). Meanwhile, when an authentication server or the like on a network is to be used, the controller 11 can transmit the entered login user name and login password to the authentication server, and receive a result of the authentication from the authentication server, thereby performing the user authentication.

The OK button B20 is an input button which receives an instruction to confirm the input operation by the user. The OK button B20 receives the inputs to the login user name input box Bx10 and the login password input box Bx12, and the specification of the authentication destination via the authentication destination specification button B 18. The cancel button B22 is an input button which receives input of an instruction to cancel the input operation by the user.

When the user authentication via the authentication screen W50 is successful, the controller 11 displays, for example, a home screen W10 or the like exemplified in FIG. 9A on a display 13.

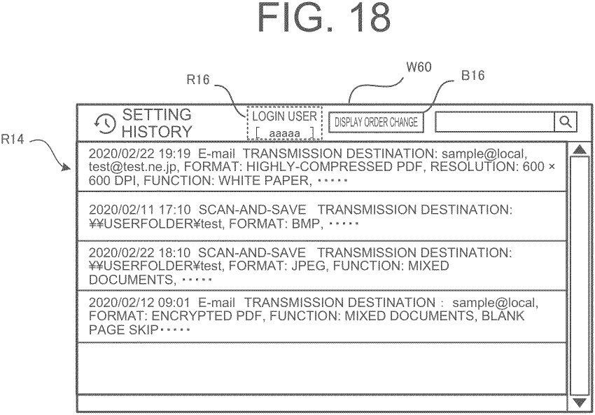

FIG. 18 shows a configuration example of a setting history display screen W60 according to the second embodiment. In the setting history display screen W60, in addition to the screen configuration of the setting history display screen W40 exemplified in FIG. 12, a login user name display area R16 is provided.

The login user name display area R16 is a display area for displaying the name of a login user authenticated by the controller 11.

FIG. 18 illustrates an example in which necessity determination processing is applied to pieces of setting history information corresponding to jobs executed by a user with the login user name “aaaaa”. In this case, the controller 11 displays only the pieces of setting history information executed by the user with the login user name “aaaaa” (refer to FIGS. 3A and 4) in a setting history information display area R14.

In FIG. 18, among the pieces of setting history information related to jobs executed by the user with the login user name “aaaaa”, the setting history information (for example, history ID “0099”) whose necessity is low is excluded from a target of display. However, it is of course possible to adopt a mode of displaying all pieces of the setting history information related to the login user “aaaaa” unless, for example, the number of pieces of setting history information to be displayed reaches the number of enabled displays.

As described above, according to the second embodiment, advantages in addition to those of the first embodiment can be obtained. That is, since pieces of setting history information related to jobs executed by a login user and are of high necessity are treated as a target of display, the login user can ascertain with accuracy the setting history information that the user himself/herself wishes to use, among the pieces of setting history information related to jobs executed by himself/herself. Further, since pieces of setting history information related to jobs executed by the other users are not treated as a target of display, it is possible to prevent personal information such as destination information used in a fax job, an e-mail transmission job, or the like, from being leaked by mistake, and security can also be ensured.

### 3. Third Embodiment

A third embodiment corresponds to a mode of restricting display of setting history information related to a job whose execution is disabled or restricted due to the effect of a restriction setting other than items pertaining to the setting history information.

The restriction setting mentioned above refers to the setting of restricting execution of the entire job or a part of the function regardless of the setting contents in the setting history information, such as prohibition of copying in a color mode, or prohibition of external communication in a time period outside working hours (business hours). For example, when a color mode prohibition setting which prohibits copying in a color mode is set as the restriction setting, even if setting history information related to a color copy job is selected, execution of the job is disabled or execution thereof is restricted. Similarly, when a time period restriction which prohibits external communication during a period outside a specific time period is set as the restriction setting, even if setting history information related to an image transmission job, such as e-mail transmission or fax transmission, is selected, execution of the job is disabled or execution thereof is restricted. The third embodiment restricts display of setting history information related to a job, which is to be affected by such restriction settings.

### 3.1 Functional Configuration

Since the functional configuration of a multifunction peripheral according to the third embodiment can be made substantially the same as that of the multifunction peripheral 10 according to the first embodiment, description thereof is omitted.

### 3.2 Flow of Processing

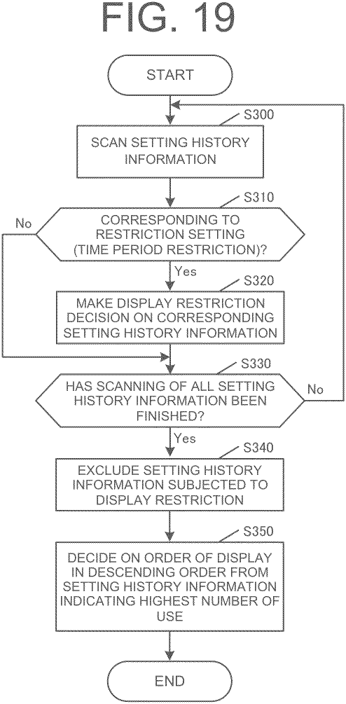

Next, a flow of processing according to the third embodiment will be described. FIG. 19 is a flowchart illustrating setting history display processing according to the third embodiment. In FIG. 19, description is given assuming that a time period setting, which restricts execution of a specific function depending on a time period, is set as the restriction setting.

When a controller 11 receives an instruction to display setting history information, the controller 11 starts scanning of pieces of setting history information stored in a setting history information storage area 236 (step S300).

The controller 11 determines whether or not the reception time when an input of an instruction to display setting history information is received corresponds to the restriction setting (time period restriction) by which execution of a job is restricted depending on a time period (step S310).

In this case, the controller 11 acquires the reception time by a timing technique such as a timer (not illustrated). Then, the controller 11 determines whether the acquired reception time corresponds to the restriction setting (time period restriction). Note that the restriction setting (time period restriction) may be set by a specific time period (for example, 6:30 p.m. to 9:15 a.m.), or may be in units of minutes, hours, days, weeks, or months, or may be a specific date.

If it is determined that the acquired reception time corresponds to the restriction setting, the controller 11 decides to restrict the display of setting history information related to a job whose function is restricted by the restriction setting in question (step S310; Yes → step S320). Meanwhile, if it is determined that the acquired reception time does not correspond to the restriction setting, the controller 11 shifts the processing to step S330 (step S310; No → step S330).

Next, the controller 11 determines whether or not scanning of all pieces of the setting history information has been finished (step S330). If it is determined that scanning of all pieces of the setting history information has been finished, the controller 11 excludes the setting history information subjected to a display restriction from pieces of setting history information related to decision on order of display (step S330; Yes → step S340).

Meanwhile, if it is determined that scanning of all pieces of the setting history information has not been finished, the controller 11 returns the processing to step S300, and starts scanning of the next piece of setting history information (step S330; No → step S300).

The controller 11 decides on the order of display, for the remaining pieces of setting history information in which the setting history information subjected to the display restriction is excluded, in descending order from the setting history information indicating the highest number of use, and ends the processing (step S350). When pieces of setting history information to be displayed are few, or depending on the setting made by the user, processing of deciding on the order of display of the pieces of setting history information related to step S350 may be omitted.

### 3.3 Operation Example

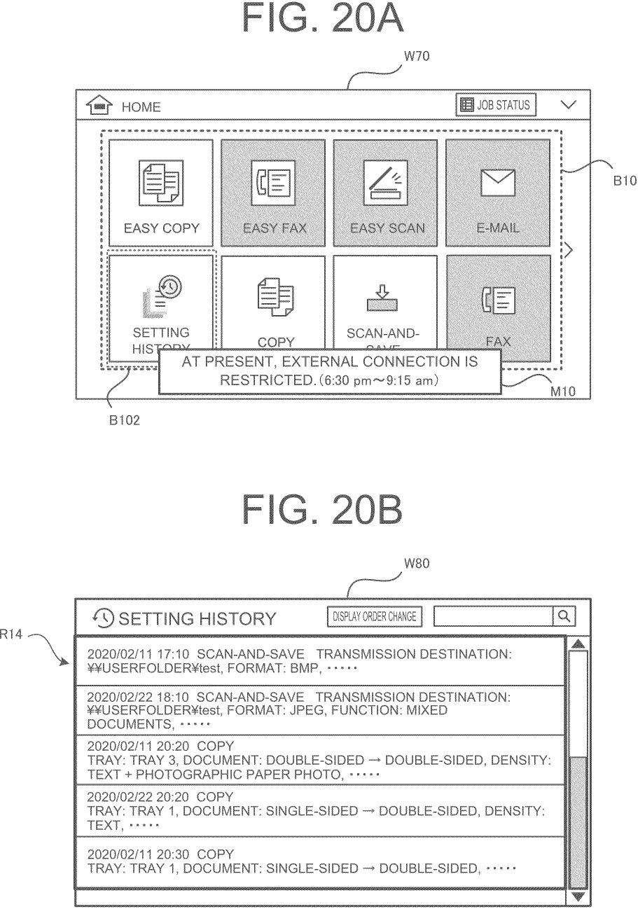

Next, an operation example according to the third embodiment will be described. FIG. 20A is a diagram illustrating a configuration example of a home screen W70 according to the third embodiment. The home screen W70 can be made the same as the home screen W10 exemplified in FIG. 9A of the first embodiment in the configuration. However, the home screen W70 is different from the home screen W10 in that the home screen W70 is configured to be able to notify the user that a restriction setting (time period restriction) which prohibits use of a specific function is applied.

The home screen W70 includes a message screen M10, in addition to mode selection buttons B10. The message screen M10 can display a message indicating that a restriction setting (time period restriction) which prohibits use of a specific function is applied, depending on a time period. FIG. 20A shows an example in which a message, which is “At present, external connection is restricted. (6:30 p.m. to 9:15 a.m.)″ indicating that external connection using a multifunction peripheral 30 is restricted from 6:30 p.m. to 9:15 a.m., is displayed in the message screen M10.

As exemplified in FIG. 20A, when a restriction setting (time period restriction) which prohibits use of a specific function is applied, the relevant mode selection buttons B10 (e.g., Easy Fax, Easy Scan, E-mail, and Fax) may be grayed out so that the execution of the specific function (external connection) is disabled. As can be seen, by graying out the mode selection buttons B10 related to the specific function, the user can visually understand that the restriction setting is applied to the specific function.

FIG. 20B shows a configuration example of a setting history display screen W80 to be displayed, when a setting history button B102 is selected from among the mode selection buttons B10 on the home screen W70 exemplified in FIG. 20A.

When the setting history button B102 is selected, the controller 11 executes the setting history display processing described referring to FIG. 19. The controller 11 decides on order of display, for the remaining pieces of setting history information in which setting history information subjected to a display restriction is excluded, in descending order from the setting history information indicating the highest number of use. Therefore, as illustrated in FIG. 20B, the controller 11 excludes pieces of setting history information related to modes (such as E-mail, scan, and fax) associated with a specific function (external connection) from a target of display, and displays, in a setting history information display area R14, a result of the decision made on order of display with the remaining pieces of setting history information pertaining to scan-and-save, copy, and the like.

As described above, according to the third embodiment, display of pieces of setting history information, which are related to jobs whose execution is disabled or restricted due to the effect of a restriction setting, is restricted. Therefore, it is possible to prevent the user from selecting these pieces of setting history information, and only the setting history information which can be used for execution can be displayed with high accuracy.

### 4 Fourth Embodiment

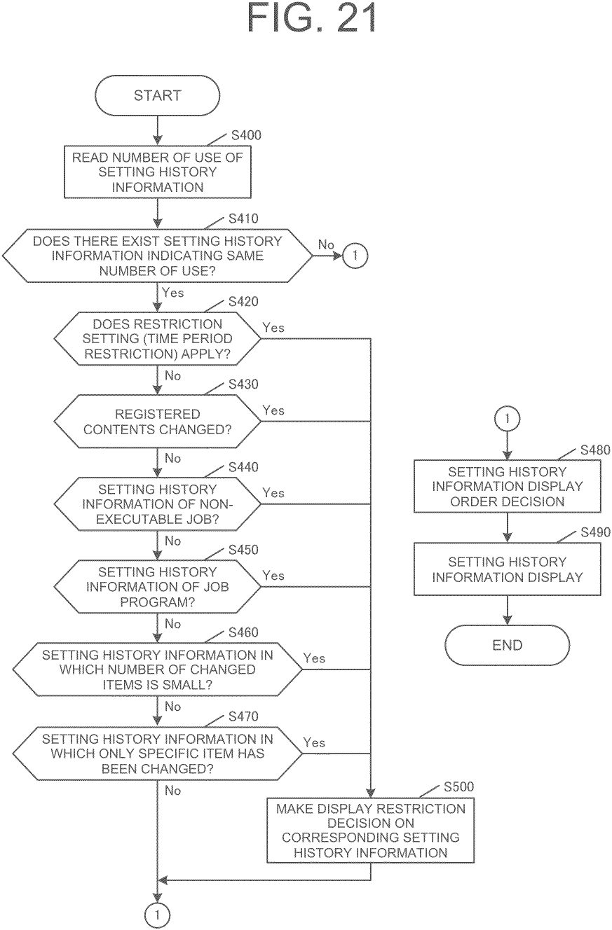

A fourth embodiment corresponds to a mode of combining and applying the determination methods (evaluation criteria) exemplified in FIG. 13 according to the order of priority. The order of priority in the fourth embodiment is intended as the order of application in which the determination methods exemplified in FIG. 13 are applied. That is, the higher the order of priority of the determination method is, the more the determination method is applied on the upstream side in the processing to be described referring to FIG. 21, and a display restriction is applied to the setting history information satisfying the applicable determination (evaluation criteria).

### 4.1 Functional Configuration

Since the functional configuration according to the fourth embodiment can be made substantially the same as that of the multifunction peripheral 10 according to the first embodiment, description thereof is omitted.

### 4.2 Flow of Processing

FIG. 21 is a flowchart illustrating processing of deciding on order of display of pieces of setting history information, on the basis of different evaluation criteria exemplified in FIG. 13, when the number of use is the same number for the pieces of setting history information that have been read.

First, a controller 11 reads a number of use of each piece of setting history information (step S400). Next, the controller 11 determines whether there exist pieces of setting history information indicating the same number as the number of use in the pieces of setting history information that have been read (step S410).

When it is determined that there exist pieces of setting history information indicating the same number as the number of use, the controller 11 determines whether or not a restriction setting (for example, a time period restriction) described in the third embodiment is applied (step S410; Yes → step S420). If it is determined that a restriction setting (time period restriction) is applied, the controller 11 decides to restrict display of the corresponding setting history information (step S420; Yes → step S500).

Meanwhile, if it is determined that no restriction setting (time period restriction) is applied, the controller 11 determines whether or not the contents initially registered as the setting history information have been changed (step S420; No → step S430). Note that the determination related to step S430 corresponds to determination method (7) of FIG. 13. If it is determined that a change is made to the contents registered as the setting history information, the controller 11 decides to restrict display of the corresponding setting history information (step S430; Yes → step S500). Determination method (7) corresponds to an evaluation criterion related to deletion or edit of a destination of a registered address book. However, as long as the method pertains to an embodiment in which job execution is disabled when the registered contents of the setting history information are changed, the evaluation criterion is not limited to the above.

Meanwhile, if it is determined that no change is made to the contents registered as the setting history information, the controller 11 determines whether or not the setting history information corresponds to one related to a job (non-executable job) which has not been executed due to occurrence of a jam, a cancel operation, or occurrence of an error, etc. (step S430; No → step S440). Note that the determination related to step S440 corresponds to determination method (8) of FIG. 13. If it is determined that the setting history information relates to a non-executable job, the controller 11 decides to restrict display of the corresponding setting history information (step S440; Yes → step S500).

Meanwhile, if it is determined that the setting history information does not relate to a non-executable job, the controller 11 determines whether or not the setting history information relates to a job executed from a job program (step S440; No → step S450). Note that the determination related to step S450 corresponds to determination method (5) of FIG. 13. If it is determined that the setting history information relates to a job executed from a job program, the controller 11 decides to restrict display of the corresponding setting history information (step S450; Yes → step S500).

Meanwhile, if it is determined that the setting history information does not relate to a job executed from a job program, the controller 11 determines whether or not the setting history information corresponds to one in which the number of items of setting value changed from the initial value is small (step S450; No → step S460). Note that the determination related to step S460 corresponds to determination method (2) of FIG. 13. If it is determined that the setting history information corresponds to one in which the number of items of changed setting value is small, the controller 11 decides to restrict display of the corresponding setting history information (step S460; Yes → step S500). It is assumed a case where there exist a plurality of pieces of setting history information in which the number of items of setting value changed from the initial value is small. In this case, for example, it is possible to preferentially restrict display of the setting history information in which only a specific item (e.g., the number of copies) that is varied each time a job is executed is changed, which will be described in step S470 below.

Meanwhile, if it is determined that the setting history information does not correspond to one in which the number of items of changed setting value is small, the controller 11 determines whether or not the setting history information corresponds to one in which only a specific item has been changed (step S460; No → step S470). Note that the determination related to step S470 corresponds to determination method (4) of FIG. 13. If it is determined that the setting history information corresponds to one in which only a specific item has been changed, the controller 11 decides to restrict display of the corresponding setting history information (step S470; Yes → step S500).

Meanwhile, if it is determined that the setting history information does not correspond to one in which only a specific item has been changed, the controller 11 determines that there exist no setting history information for which display is to be restricted, and decides on order of display of the pieces of setting history information (step S470; No → step S480). Then, the controller 11 displays, in accordance with the decided order of display, the pieces of setting history information, and ends the processing (step S490).

Incidentally, if it is determined that there exist no pieces of setting history information indicating the same number as the number of use, the controller 11 decides on order of display of the pieces of setting history information (step S410; No → step S480). Then, the controller 11 displays, in accordance with the decided order of display, the pieces of setting history information, and ends the processing (step S490).

In FIG. 21, an example in which the order of priority of the determination methods to be applied is in the order of determination method (7), determination method (8), determination method (5), determination method (2), and determination method (4) has been described. However, the order of priority is not limited to the above, and may be set or changed as appropriate.

### 4.3 Operation Example

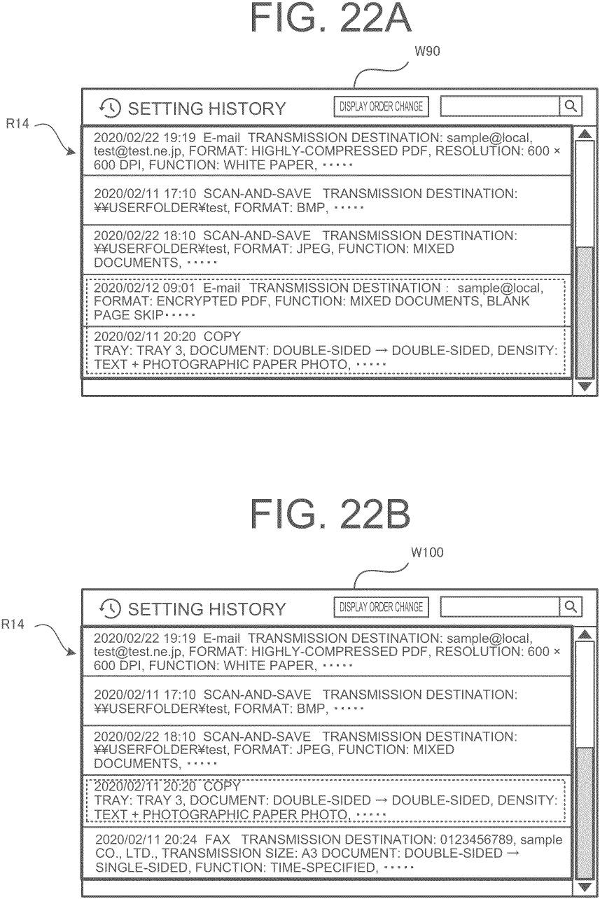

Next, an operation example according to the fourth embodiment will be described. FIG. 22A shows a display mode corresponding to the first embodiment, and is a display example of pieces of setting history information when the number of use includes the same number. In FIG. 22A, pieces of setting history information indicated in a dotted frame, i.e., the setting history information related to E-mail executed on Feb. 12, 2020, at 09:01 (history ID “0095”) and the setting history information related to copy executed on Feb. 11, 2020, at 20:20 (history ID “0092”), are an example of the setting history information in which the number of use of each piece of the setting history information is twice. In the first embodiment, for pieces of setting history information indicating the same number as the number of use, the order of display is decided such that the setting history information with the newer job execution date and time comes at an upper position. Therefore, each of the pieces of setting history information represented as history ID “0095” and setting history information represented as history ID “0092” is displayed in the order of display exemplified in FIG. 22A.

In contrast, FIG. 22B shows a display mode corresponding to the fourth embodiment, which decides on order of display of pieces of setting history information on the basis of a different evaluation criterion, when the number of use includes the same number. For example, when a restriction setting (time period restriction) is applied to the setting history information related to history ID “0095”, the controller 11 decides that the setting history information related to history ID “0095” corresponds to setting history information to which a display restriction is to be applied, on the basis of the processing related to step S420 of FIG. 21. The controller 11 does not display the setting history information related to history ID “0095”, but displays only the setting history information related to copy represented as history ID “0092” to which no restriction setting (time period restriction) is applied.

As described above, according to the fourth embodiment, by combining and applying the determination methods based on different evaluation criteria according to the order of priority, it is possible to carefully examine the setting history information for which display is to be restricted with a different evaluation criterion.

The present disclosure is not limited to the embodiments described above, and various modifications can be made. That is, the technical scope of the present disclosure also includes an embodiment obtained by combining technical measures modified as appropriate without departing from the spirit of the present disclosure.

Further, although some parts of the above embodiments have been described separately for convenience of explanation, it is needless to say that the embodiments may be combined within a technically possible range and implemented.

In addition, the program to be operated on each of the devices in the embodiments is a program that controls the CPU or the like (i.e., a program which makes a computer function) so as to implement the functions of the above-described embodiments. The information handled by the devices is temporarily accumulated in a temporary storage device (for example, a RAM) during processing of the information, and then, is stored in various storage devices such as a read-only memory (ROM) and an HDD, and is read, modified, and written by the CPU as necessary.

A recording medium used for storing the program may be any one of a semiconductor medium (for example, a ROM, a non-volatile memory card, or the like), an optical recording medium or a magnetooptical recording medium (for example, a digital versatile disc (DVD), a magnetooptical disc (MO), a mini disc (MD), a compact disc (CD), a Blu-ray (registered trademark) disc (BD), or the like), and a magnetic recording medium (for example, a magnetic tape, a flexible disk, or the like). Further, not only are the functions of the above-described embodiments implemented by execution of the loaded program, but the functions of the present disclosure may also be implemented by processing performed in cooperation with an operating system or other application programs, etc., on the basis of the instructions of the program.

Furthermore, when the program is to be distributed to the market, the program may be stored in a portable recording medium for distribution or transferred to a server computer connected via a network such as the Internet. In this case, a storage device of the server computer is also included in the present disclosure as a matter of course.

What is claimed is:

1. A display processing apparatus comprising:
a display which allows setting history information related to execution of a job to be displayed; and
a controller which controls execution of the job by using the setting history information,
wherein the controller:
determines necessity of the setting history information for the execution of the job; and
excludes, from pieces of setting history information each corresponding to the setting history information, the setting history information being low in the necessity, and decides on order of display of the pieces of setting history information to be displayed on the display.

2. The display processing apparatus according to claim 1, wherein:
the controller determines the necessity based on a number of use;
the controller determines that the necessity is low with respect to the setting history information being low in the number of use; and
the controller decides on the order of display in descending order from the setting history information indicating the highest number of use.

3. The display processing apparatus according to claim 1, wherein:
the controller determines the necessity based on the number of items changed from an initial value;
the controller determines that the necessity is low with respect to the setting history information in which the number of items changed from the initial value is small; and
the controller decides on the order of display in descending order from the setting history information in which the number of items changed from the initial value is the largest.

4. The display processing apparatus according to claim 1, wherein:
the controller determines the necessity based on a number of use of a job type;
the controller determines that the necessity is low with respect to the setting history information of the job type being low in the number of use; and
the controller decides on the order of display in descending order from the setting history information of the job type indicating the highest number of use.

5. The display processing apparatus according to claim 1, wherein:
the controller determines the necessity based on a change history of a specific item;
the controller determines that the necessity is low with respect to the setting history information in which only the specific item is changed; and
the controller decides on the order of display of the pieces of setting history information in which the specific item is unchanged.

6. The display processing apparatus according to claim 1, wherein:
the controller determines the necessity based on a batch setting in which settings related to processing of the job are registered in a batch;
the controller determines that the necessity is low with respect to the setting history information of the job executed by invoking the batch setting; and
the controller decides on the order of display of the pieces of setting history information that are not executed by invoking the batch setting.

7. The display processing apparatus according to claim 1, wherein:
the job includes a transmission job in which a destination selected from a registered address book is used as a transmission destination;
the controller determines the necessity based on the destination;
the controller determines that the necessity is low with respect to the setting history information of the transmission job in which the destination is selected from the address book alone; and
the controller decides on the order of display of the pieces of setting history information in which the destination is not selected from the address book alone.

8. The display processing apparatus according to claim 7, wherein:
the controller determines that the necessity is low with respect to the setting history information in which the destination of the address book is deleted or edited; and
the controller decides on the order of display of the pieces of setting history information in which the destination of the address book is not deleted or edited.

9. The display processing apparatus according to claim 1, wherein:
the controller determines the necessity based on a cancellation history of the job_{;}
the controller determines that the necessity is low with respect to the setting history information of the job canceled by a user; and
the controller decides on the order of display of the pieces of setting history information of the job not canceled by the user.

10. The display processing apparatus according to claim 1, wherein the controller displays, when user authentication is enabled, only the setting history information pertaining to the authenticated user on the display.

11. The display processing apparatus according to claim 1, wherein:
the controller determines the necessity based on a restriction setting other than an item pertaining to the setting history information;
the controller determines that the necessity is low with respect to the setting history information related to the job which is restricted or prohibited by being affected by the restriction setting; and
the controller decides on the order of display of the pieces of setting history information not being affected by the restriction setting.

12. The display processing apparatus according to claim 1, wherein:
the display allows the setting history information to be displayed in order of execution of the job; and
the controller changes the order of display of the pieces of setting history information from the order of execution of the job to the decided display order.

13. The display processing apparatus according to claim 1, wherein the controller lowers the order of display of the setting history information that is determined as being low in the necessity.

14. An image processing apparatus comprising:
the display processing apparatus according to claim 1; and
an image processor which performs image processing based on the job.

15. A display processing method comprising:
displaying setting history information related to execution of a job on a display device; and
controlling execution of the job by using the setting history information,
wherein the controlling includes:
determining necessity of the setting history information for the execution of the job; and
excluding, from pieces of setting history information each corresponding to the setting history information, the setting history information being low in the necessity, and deciding on order of display of the pieces of setting history information to be displayed on the display device.
